(19) United States
(12) Patent Application Publication
(10) Pub. No.: US 2014/0097616 A1
(43) Pub. Date: Apr. 10, 2014

(54) DEVICE FOR CENTERING AND CLAMPING TUBULAR PARTS

(71) Applicants: Gilles RICHARD, Silly Le Long (FR); Jean-Francois Dagenais, Cassis (FR); Denis Destouches, Dampleux (FR)

(72) Inventors: Gilles RICHARD, Silly Le Long (FR); Jean-Francois Dagenais, Cassis (FR); Denis Destouches, Dampleux (FR)

(73) Assignee: SERIMAX, Mitry Mory (FR)

(21) Appl. No.: 14/052,407

(22) Filed: Oct. 11, 2013

Related U.S. Application Data
(63) Continuation of application No. 11/917,784, filed on Jul. 7, 2008, now abandoned.

(30) Foreign Application Priority Data
Jun. 17, 2005 (FR) 0506166

(51) Int. Cl. F16L 19/06

(52) U.S. Cl. CPC F16L 19/06
USPC 285/421

(57) ABSTRACT

A device for centering and clamping tubular parts such as conduits designed to form pipeline pipes of the type consisting of an elongated cylinder comprising in particular a clamping device, such as at least clamping shoes arranged over its entire periphery and adapted to be radially mobile projecting from said cylinder to be urged to press against the walls of the conduits to be clamped as well as means for moving each of the series of clamping shoes between a position projecting from the cylinder and a position wherein they are retracted into the cylinder

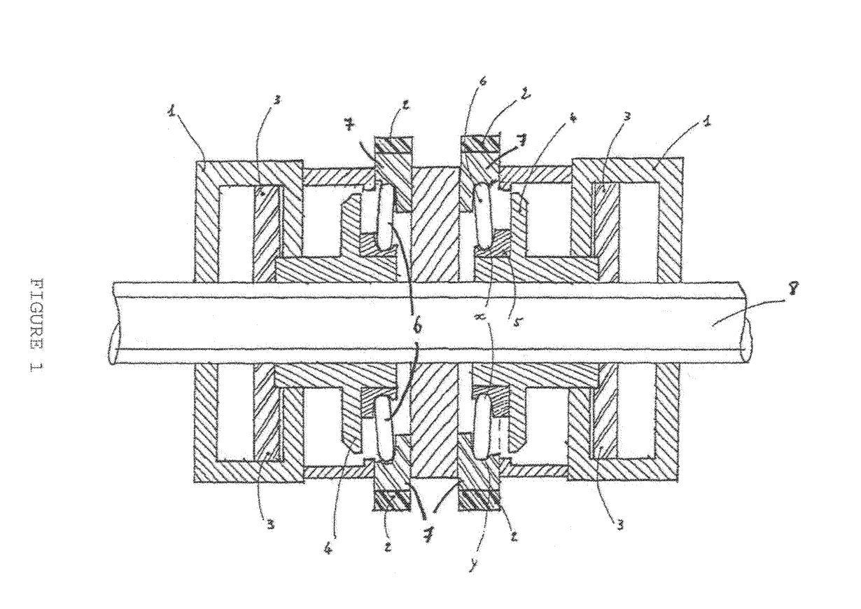

This application is a continuation of U.S. application Ser. No. 11/917,784 filed Jul. 7, 2008, which is the National Stage Application of PCT International Application Serial No. PCT/FR2006/001383 filed Jun. 19, 2006, which claims priority to French Application No. 0506166 filed Jun. 17, 2005. The entire content of U.S. application Ser. No. 11/917,784 filed Jul. 7, 2008, is incorporated herein by reference.

The present invention concerns a device for centering and clamping tubular parts such as metal conduits, concentrically abutted in order to be welded to form the metal pipes of pipelines.

Upon welding of these conduits, it is indispensable for the axes of said conduits to be correctly aligned and for the aligned conduits to be maintained during welding. In fact, in case of misalignment of the axes, the assembly joint between the conduits is then irregular, which from the standpoint of quality of the weld, can lead to the creation of defects. A centering and clamping device makes it possible, therefore, to align the conduits with a view to their welding and to maintain that alignment during welding. Such devices are described, in particular, in EP 1,123,774 and EP 076,719.

A standard device of this type consists of an elongated cylinder which bears clamping means, such as clamping shoes, arranged over its entire periphery and adapted to be radially mobile in projection from said cylinder in order to press against the walls of the conduits to be clamped, said device also containing drive means enabling it to be moved inside the conduits, once welding is carried out and the shoes are retracted.

The present devices generally have, for each set of clamping shoes, a central piston which pushes a bulky part in which link rod shafts are inserted, pushing the link rods which then push shafts driving pistons bearing the clamping shoes in radial guides to move the clamping shoes in radial projection in order to press them against the inner surface of the conduits to be assembled.

Such a device has numerous disadvantages, such as weakness on shearing at the shafts at each end of the link rods and the need to provide a center part by conduit diameter as well as a limited thrust of the piston to approximately 10 tons. Furthermore, the shafts are kept fixed in forged or machined parts in the mass, so that when there is a deformation of a shaft bearing and the need to change it, it is then necessary to change the assembly. Such devices are described, in particular, in patents U.S. Pat. No 4,253,599, WO 00/00322 and U.S. Pat. No. 5,288,005.

In addition, on laying conduits with appreciably horizontal axes, an imbalance is observed in wear of the parts, the parts or pistons in lower position having to be changed much more often, which is a major disadvantage.

U.S. Pat. No. 4,582,241 describes a clamping and centering device for tubular conduits to be butt-welded, in which the drive means consist of a piston connected by a sliding cylinder sleeve on a shaft, that sleeve contains spaces on its periphery forming seats for spherical or round-head joint rods for the connection to radially disposed shafts bearing the clamping shoes. The shafts also contain spherical seats, the end of the joint rod being spherical or circular.

Such a device can possibly enable the shearing forces on the shafts holding the joint rods to be avoided; however, it requires joint rods which are very specifically machined, the parts forming a seat for said rods also being of a specific shape. Such a device is then relatively complex to make and, therefore, expensive.

### BRIEF DESCRIPTION OF THE SEVERAL VIEWS OF THE DRAWINGS

The single FIGURE is an exemplary view of an embodiment according to the present disclosure.

### DETAILED DESCRIPTION OF THE INVENTION

In order to overcome these problems, this invention is intended to provide a device for centering and clamping tubular parts, such as conduits designed to form pipeline pipes, of the type consisting of an elongated cylinder, notably, containing clamping means, such as at least one series of clamping shoes, arranged over its entire periphery and adapted to be radially mobile on projection from said cylinder in order to press against the walls of the conduits to be clamped, as well as means for moving each series of clamping shoes between a position projecting from the cylinder and a position in which they are retracted into the cylinder, characterized in that said drive means consists of a drive member detachably connected to a plate which bears a plurality of supporting parts on which the first end of a link rod is mounted pivoting around an axis like a swivel joint, the second end of the link rod also being mounted pivoting around an axis like a swivel joint in a second supporting part bearing a clamping shoe, the sliding movement of the drive member in a longitudinal direction of the cylinder causing pivoting of the first end of the link rods, while the pivoting resulting from the second end of the link rods causes the radial displacement of the associated clamping shoe.

The link rods of the device according to the invention advantageously work solely by compression, which makes it possible to generate a thrust effort of up to 60 tons. The shafts used for mounting a link rod in the supporting parts play no role in the thrust effort, which advantageously limits their wear, but solely have a function of return movement of the supporting parts. Furthermore, the link rod is of simple design, not requiring any particular shape, in contrast to the joint rods of the state of the art and, therefore, being economical.

Each supporting part has a seat in which the end of a link rod is housed pivoting. Each supporting part, each seat and each drive member, such as a piston, are the same, whatever the diameter.

In addition, as it is no longer necessary to insert shafts in a bulky part, it is possible to join the supporting parts bearing the clamping shoes and, therefore, increase their number, which results in an improvement of clamping.

The supporting parts assembly, link rods and supporting parts bearing the shoes, preferably has greasing means in place.

It is possible to provide several plates on the same thrust shaft for small diameters, so as to permit sufficient thrust.

According to a preferred embodiment of the invention, the device preferably contains a hollow shaft in its center, defining the central axis of the device and providing the device with rigidity, while making possible the conveyance of all the cables and hoses.

The device according to the invention, therefore, makes it possible to obtain an improved transmission of stress, while having easily removable wear parts, which greatly facilitate maintenance and repair in contrast to the previous devices.

The centering and clamping device according to the invention can be of the type equipped with a support lath or can even be of the type provided with a welding member making a pass inside.

The device according to the invention advantageously further contains at least two different centering members of the clamping shoes and consisting respectively of at least one inflatable member that can be fixed on the periphery of the elongated cylinder.

The invention will now be described more in detail with reference to the drawing, in which the single figure represents a longitudinal cutaway of a device according to the present invention.

The centering and clamping device according to the invention represented in the single figure consists of an elongated cylinder 1 which contains, notably, clamping means making possible the clamping of conduits to be aligned, in which said device is engaged.

These clamping means consist of at least one series of clamping shoes 2, arranged on the entire periphery of the cylinder 1 and adapted to be moved radially projecting from said cylinder 1 in order to press against the walls of the conduits to be clamped.

In the single figure, two series of shoes 2 are represented (one series for each end of the conduits to be assembled), but it is also possible to use only one series of shoes, with the end of the shoes U-shaped, bearing on each of the ends to be assembled.

Drive means moving each series of clamping shoes are provided to drive said shoes between the projecting position of the cylinder 1 and the position in which they are retracted in the cylinder 1.

These drive means consist of a drive member 3, such as a pneumatic or hydraulic pistons detachably connected to a plate 4. That circular plate 4 bears on its periphery a plurality of supporting parts 5, on each of which the first end of a link rod 6 is mounted pivoting on an axis x like a swivel rod.

The second end of the link rod 6 is also mounted pivoting on an axis y like a swivel rod in a second supporting part also called piston 7, bearing a clamping shoe 2, the sliding drive of the drive member 3 in a longitudinal direction of the cylinder 1 causing pivoting of the first end of the link rods 6, while the pivoting resulting from the second end of the link rods 6 produces a radial displacement of the associated clamping shoe 2.

Greasing means are preferably provided in place for the link rods 6.

The clamping means, as described, can likewise serve for centering the conduits, but it is also possible to provide other centering means, such as elements fixed to the periphery of the cylinder 1 and inflatable.

For each set of clamping shoes, there are displacement drive means.

When the centering device is intended to be used for small diameter conduits, a series of plates can be provided on the same thrust shaft, and, therefore, pneumatic or hydraulic chambers, in order to increase the coating force with a same base pressure.

As can be seen, the device according to the invention has a central hollow shaft 8 making it possible, notably, to allow the assembly of cables, wires and hoses of the device to pass, as well as those belonging to assemblies situated in the back of the device, such as an interior inspection tool.

The invention is, of course, not limited to the embodiment described, but covers all the variants possible within the scope of protection of the claims.

1-6. (canceled)

7. A clamping device comprising:
a housing comprising an outer cylindrical surface and an inner cylindrical surface, the outer cylindrical surface and the inner cylindrical surface together delimiting a cylindrical wall;
a set of bores, each bore being radially arranged through the cylindrical wall, and the set of bores being circumferentially distributed in the cylindrical wall;
a set of clamping shoes, each clamping shoe being slidably mounted within a respective bore;
a main shaft, mounted within the housing, the main shaft being centered relative to the cylindrical wall;
a drive assembly mounted on the main shaft, the drive assembly being connected to the set of clamping shoes, and the drive assembly being arranged to move the set of clamping shoes within the bores, relative to the cylindrical wall, between a first position and a second position, the clamping shoes being within the cylindrical wall, between the outer cylindrical surface and the inner cylindrical surface in said first position, and the clamping shoes protruding from the outer cylindrical surface in said second position;
the drive assembly comprising:
an actuator mounted on the main shaft,
a set of supporting parts mounted on the main shaft, the set of supporting parts being slidable relative to the main shaft in a longitudinal direction thereof, and the set of supporting parts being attached to the actuator so that the actuator can move the set of supporting parts relative to the main shaft between a first position and a second position;
a set of link rods, each link rod interlinking one respective supporting part and one respective clamping shoe in such a manner that:
each link rod rotates relative to one respective supporting part according to a first rotation direction when the actuator moves the set of supporting parts from the first position to the second position thereby causing the set of clamping shoes to move from the first position to the second position;
each link rod rotates relative to one respective supporting part according to a second rotation direction, opposite to the first rotation direction, when the actuator moves the set of supporting parts from the second position to the first position, thereby causing the set of clamping shoes to move from the second position to the first position;
wherein:
each link rod has a first cylindrical end and each supporting part has a first portion complementary shaped with the first cylindrical end of one respective link rod; the drive assembly further comprises a set of axles, each axle attaching the first cylindrical end of one link rod to the first portion of one respective supporting part in such a manner that the link rod is arranged to pivot relative to the respective supporting part about one respective axle;
each axle being positioned relative to the respective supporting part and the respective first cylindrical end in such a manner that:
the first portion of the supporting part acts as a seat for the first cylindrical end of the respective link rod when the supporting part moves from the first position to the second position thereby causing the link rod to rotate relative to the supporting part according to the first rotation direction and the first cylindrical end to pivot against the first portion while the axle plays no role;
the axle acts as a pivot for the first cylindrical end of the respective link rod when the supporting part moves from the second position to the first position thereby causing the link rod to rotate relative to the respective supporting part according to the second rotation direction and the link rod to return with the supporting part.

8. A clamping device according to claim 7, wherein the actuator comprises at least one pneumatic or hydraulic piston.

9. A clamping device according to claim 7, wherein the main shaft is arranged for conveyance of cables and/or hoses.

10. A clamping device according to claim 7, further comprising:
a set of second bores, each second bore being radially arranged through the cylindrical wall and the set of second bores being circumferentially distributed in the cylindrical wall;
a set of second clamping shoes, each second clamping shoe being slidably mounted within a respective second bore;
a second drive assembly mounted on the main shaft, the second drive assembly being connected to the set of second clamping shoes, and the second drive assembly being arranged to move the set of second clamping shoes relative to the cylindrical wall between a first position and a second position, the second clamping shoes being within the cylindrical wall between the outer cylindrical surface and the inner cylindrical surface in said fast position, the second clamping shoes protruding from the outer cylindrical surface in said second position;
the second drive assembly comprising a second actuator mounted on the main shaft opposite to said actuator relative to the set of supporting parts,
wherein the main shaft is hollow and arranged for conveyance of cables and/or hoses intended to said actuator and/or the second actuator.

11. A clamping device according to claim 7, wherein the actuator comprises a number of pistons, each piston being mounted on the main shaft.

12. A clamping device according to claim 7, wherein each clamping shoe comprises a second supporting part, and each link rod has a second cylindrical end, and:
each second supporting part has a second portion complementary shaped with the second cylindrical end of one respective link rod;
each link rod rotates relative to one respective second supporting part according to the first rotation direction when the actuator moves the set of first supporting parts from the first position to the second position;
each link rod rotates relative to one respective second supporting part according to the second rotation direction when the actuator moves the set of supporting parts from the second position to the first position;
the drive assembly further comprises a set of second axles, each second axle attaching the second cylindrical end of one link rod to the second portion of one respective second supporting part in such a manner that the link rod is arranged to pivot relative to the respective second supporting part about one respective second axle;
each second axle being positioned relative to the respective second supporting part and the respective second cylindrical end in such a manner that:
the second portion of the second supporting parts acts as a seat for the second cylindrical end of the respective link rod when the supporting part moves from the first position to the second position thereby causing the link rod to rotate relative to the second supporting part according to the first rotation direction and the first cylindrical end to pivot against the first portion while the axle plays no role;
the second axle acts as a pivot for the second cylindrical end of the respective link rod when the supporting part moves from the second position to the first position thereby causing the link rod to rotate relative to the respective second supporting part according to the second rotation direction and the link rod to return with the respective second supporting part.

13. A clamping device according to claim 8, wherein the main shaft is arranged for conveyance of cables and/or hoses.
